(19) United States
(12) Patent Application Publication
(10) Pub. No.: US 2017/0167551 A1
(43) Pub. Date: Jun. 15, 2017

(54) RAIL VEHICLE BRAKE DISK

(71) Applicant: KNORR-BREMSE SYSTEME FÜR SCHIENENFAHRZEUGE GMBH, Munchen (DE)

(72) Inventors: Torsten GRUNWALD, Seehausen am Staffelsee (DE); Nicolas LANGE, Feldafing (DE)

(21) Appl. No.: 15/313,439

(22) PCT Filed: May 20, 2015
(86) PCT No.: PCT/EP2015/061187

§ 371 Date: Nov. 22, 2016

(30) Foreign Application Priority Data
May 22, 2014 (DE) 10 2014 107 229.4

(51) Int. Cl. F16D 65/00; F16D 65/12

(52) U.S. Cl. CPC F16D 65/0037; F16D 65/125; F16D 65/127; F16D 2250/0007; F16D 2200/0013; F16D 2200/0021

(57) ABSTRACT

A one-piece rail vehicle brake disk is made of steel or cast iron, comprises at least one effective surface with which a friction element comes in contact during a braking maneuver, and is designed in such a way that the effective surface has a plurality of blind holes.

### CROSS REFERENCE AND PRIORITY

### Priority Paragraph

This patent application is a U.S. National Phase of International Patent Application No. PCT/EP2015/061187, filed May 20, 2015, which claims priority to German Patent Application No. 10 2014 107 229.4, filed May 22, 2014, the disclosure of which are incorporated herein by reference in their entirety.

### FIELD

For functional reasons in particular, but also for reasons of cost, such brake disks are formed in one piece, having a continuous flat effective surface, against which a friction element is pressed during a braking operation.

### BACKGROUND

Particularly in the case of rail vehicles used in high-speed operations, there are many problems caused by the abrasion which arises during braking, resulting in the formation of accumulations, referred to as “metal pickups”, which weld to the brake disk material of the effective surface.

As a direct consequence, these welded accumulations are torn away, resulting in damage to the effective surface or even destruction.

Significant parameters affecting the formation of the accumulations are the speed of the rail vehicle, i.e. the speed of rotation of the wheel, ambient conditions, such as moisture or the like, the contact pressure of the friction element against the brake disk, the duration of frictional contact and the characteristics of the effective surface of the brake disk.

Since a brake disk is a safety-relevant component, the brake disk must therefore either be re-machined or replaced. Of course, this is possible only with considerable outlay in terms of work and hence also costs, this including not only the actual repair work but also the more or less compulsory downtimes, in which the rail vehicle cannot be used.

### SUMMARY

It is the underlying object of the disclosed embodiments to develop a brake disk of the type in question in such a way that the service life and functional reliability thereof is improved with little outlay in terms of design and production engineering.

As has been found, there is an improvement achieved by means of the disclosed embodiments, which the effective surface of the brake disk is provided with a plurality of blind openings, inasmuch as the formation of accumulations of detached abraded material, which adhere to produce welding, is now prevented.

Here, the depth of the blind openings corresponds to the maximum depth of wear, which is usually 7 mm on such brake disks.

This ensures that no weakening of the material occurs, which would have a disadvantageous effect on the operating behavior of the brake disk.

Preventing said welding leads to a significant lengthening of service life as well as an improvement in operating safety.

This results in cost savings to a quite remarkable extent, owing to the fact that re-machining or new procurement of the brake disk is no longer necessary before it wears out due to operation-related, as it were “normal”, wear.

Since, in this context, there are also no rail vehicle downtimes of the kind described in the prior art, there are also cost advantages resulting therefrom, representing a significant improvement overall.

According to an advantageous development of the disclosed embodiments, the blind openings can be configured differently in respect of their design. For example, it is conceivable to introduce blind holes into the effective surface, which can be positioned in an ordered manner, i.e. in a particular pattern, e.g. radially and/or concentrically, or in an unordered manner

This applies equally to another variant embodiment of the disclosed embodiments, according to which grooves are introduced into the effective surface, it being possible for said grooves to be introduced in a chaotic or ordered manner, e.g. in a radially aligned manner

As compared with a prior-art brake disk, the production of the novel brake disk is essentially neutral in terms of cost, wherein the blind openings are introduced by machining in the case of a brake disk made of steel, whereas they are made during the casting process in the case of a cast brake disk. Thus, re-machining of these blind openings in the case of the brake disk composed of cast iron is not necessary.

The disclosed embodiments can be implemented both on brake disks with one useful surface and on “axle-mounted brake disks” with two mutually opposite effective surfaces.

Irrespective of the operating conditions, which, as mentioned, can affect the abrasion behavior of the brake disk, including speed, ambient conditions, such as moisture or dirt, contact pressure of the friction element, and the duration of frictional contact, the service life of the brake disk is now optimized.

### BRIEF DESCRIPTION OF FIGURES

Disclosed embodiments is explained in greater detail below with reference to the drawings, in which:

FIG. 1 shows an illustrative embodiment of a brake disk according to a plan view

FIG. 2 shows the brake disk according to FIG. 1 in a partially broken-away side view

FIG. 3 shows another variant embodiment of the brake disk, likewise in a plan view

FIG. 4 shows the brake disk according to FIG. 3 in a side view, partially broken away.

### DETAILED DESCRIPTION

The figures show a one-piece rail vehicle brake disk 1 composed of steel or cast iron, having an effective surface 2, on which a friction element rests during a braking operation.

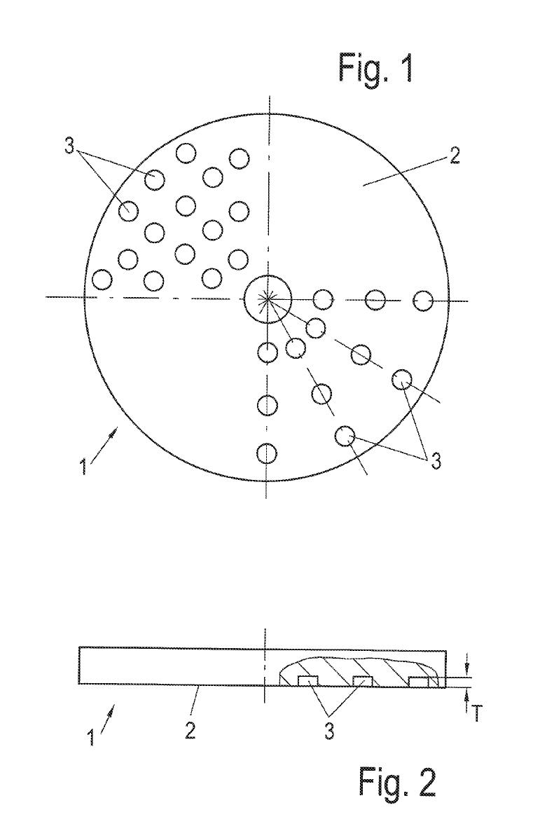

According to the disclosed embodiments, the effective surface 2 is provided with a plurality of blind openings, which consist of blind holes 3 in the example shown in FIGS. 1 and 2.

In FIG. 1, a substantially chaotic arrangement of the blind holes 3 is shown as one possibility for positioning, more specifically in the upper left-hand quarter of the circular surface.

In the lower right-hand quarter of the circular surface, there is ordered positioning of the blind holes 3 to be seen, in which said holes are aligned both radially and also in multiple concentric arrangements.

Here, the depth T of the blind holes 3 corresponds to the maximum permitted degree of wear of the effective surface 2.

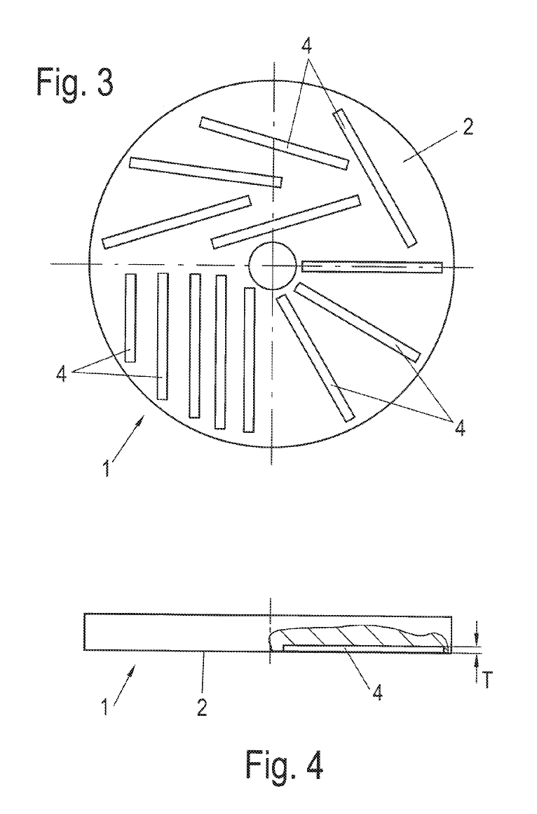

This is also the case in the example of the disclosed embodiments shown in FIGS. 3 and 4, in which the blind openings are designed as grooves 4 which, as can be seen from the upper half of FIG. 3, can be aligned in a chaotic manner, or, in accordance with the lower right-hand quarter of the circular surface, radially aligned or, in accordance with the lower left-hand quarter of the circular surface, tangentially aligned, in which case the grooves 4 are parallel and spaced apart.

In other respects, there is a free choice both of the peripheral contour of the grooves 4 and of the cross-sectional contour thereof, and it should be adapted appropriately to the most favorable functional and manufacturing conditions.

That is to say that, instead of a rectangular shape, the grooves 4 can also be in the form of an elongate hole with rounded ends.

The cross-sectional contour of the grooves 4 can also assume any desired suitable shape, i.e. can be U-shaped, for example, with a rounded bottom or triangular.

There is likewise a free choice as regards the outline of the blind holes 3 shown in FIG. 3, i.e. they can have some other contour, and can likewise taper inward in a funnel shape.

In principle, there is a free choice as regards the number, shape and arrangement of the blind openings and, as has been mentioned, the choice depends on the functional requirements and cost minimization.

1. A one-piece rail vehicle brake disk composed of steel or cast iron, having at least one effective surface, on which a friction element rests during a braking operation, wherein that the effective surface is provided with a plurality of blind openings.

2. The brake disk of claim 1, wherein the blind openings correspond in depth approximately to the maximum permissible depth of wear of the brake disk.

3. The brake disk as claimed in of claim 1, wherein the blind openings are in an ordered or unordered pattern.

4. The brake disk of claim 1, wherein the blind openings are designed as blind holes or grooves.

5. The brake disk of claim 1, wherein the blind holes have a round or oval outline.

6. The brake disk of claim 1, wherein the blind holes are of cylindrical or funnel-shaped design.

7. The brake disk of claim 1, wherein the blind holes are arranged concentrically and/or radially.

8. The brake disk of claim 1, wherein the grooves are arranged radially or tangentially.

9. The brake disk of claim 1, wherein the blind openings are introduced by machining or during casting.
